(19) United States
(12) Patent Application Publication
(10) Pub. No.: US 2015/0106821 A1
(43) Pub. Date: Apr. 16, 2015

(54) APPARATUS AND METHOD FOR ALLOCATING MULTIPLE TASKS

(71) Applicant: Electronics and Telecommunications Research Institute, Daejeon (KR)

(72) Inventors: Juneyoung CHANG, Daejeon (KR); Yookyoung LEE, Daejeon (KR); Kyungjin BYUN, Daejeon (KR); Nakwoong EUM, Daejeon (KR)

(21) Appl. No.: 14/502,459

(22) Filed: Sep. 30, 2014

(30) Foreign Application Priority Data
Oct. 16, 2013 (KR) 10-2013-0123047

(51) Int. Cl. G06F 9/50

(52) U.S. Cl. CPC G06F 9/5005
USPC 718/104

(57) ABSTRACT

An apparatus and method for allocating multiple tasks are disclosed. The apparatus for allocating multiple tasks includes a clustering unit and an allocation unit. The clustering unit clusters tasks, generated when application software (SW) operates in an SW platform, based on the application SW. The allocation unit allocates the clustered tasks to a cluster core corresponding to the application SW and allocates the clustered tasks to a core having a distance of one hop from the cluster core.

### CROSS-REFERENCE TO RELATED APPLICATION

This application claims the benefit of Korean Patent Application No. 10-2013-0123047, filed Oct. 16, 2013, which is hereby incorporated by reference in its entirety into this application.

### BACKGROUND OF THE INVENTION

1. Technical Field

The present invention relates generally to an apparatus and method for allocating multiple tasks and, more particularly, to technology that efficiently allocates multiple tasks to an application-specific star-type NoC architecture in a heterogeneous multi-core platform, thereby being able to reduce both communication overhead and power consumption and also to improve the performance of the overall system.

2. Description of the Related Art

As the computational complexity of an embedded application increases, a multi-core platform in which pluralities of processors and cores have been integrated into a system on chip (SoC) has been required. In order to meet the computational complexity of an application field in a multi-core platform, the multiple tasks of application software (SW) needs to be effectively allocated.

Communication architectures for allocating multiple cores and multiple pieces of hardware (HW) to a multi-core platform include point-to-point (PTP), on-chip bus (OCB), and network-on-chip (hereinafter referred to as an “NoC”) architectures.

An NoC architecture has excellent parallelism for resolving a delay time problem attributable to the use of the shared bus of the PTP and OCB architectures and high scalability, and thus is widely used as the communication architecture of a multi-core platform.

A multi-core platform includes a general purpose processor (GPP), a graphic processing unit (GPU), a digital signal processor (DSP), dedicated IP-cores (e.g., multimedia and communication cores), local memory (e.g., ROM or RAM), global memory (GM) (e.g., SDRAM), and a communication architecture (e.g., an on-chip bus or an NoC).

Multi-core platforms may be classified into homogeneous multi-core platforms formed of the same cores and heterogeneous multi-core platforms formed of different cores depending on HW components that form the multi-core platform.

For example, Korean Patent Application Publication No. 10-2011-0128023 entitled “Multi-Core Processor, Apparatus and Method for Task Scheduling of Multi-Core Processor” to which the same multi-core processor has been applied discloses a method of allocating tasks while taking into consideration the temperature of the same multi-core processor, the characteristic of the amount of emitted heat of a task, and real-time characteristics.

Recently, heterogeneous multi-core platforms capable of meeting the performances of most of application fields have been widely used.

The performance and power consumption of the overall system may be affected by a method of mapping various applications (e.g., multimedia, graphics, communication, a game, and a web application) to a multi-core platform. Various applications may be mapped to a multi-core platform using a design-time (static) mapping method and a run-time (dynamic) mapping method. The design-time (or static) mapping method is an allocation method that is used when a multi-core platform suitable for an application field is designed. This method is not suitable for a dynamic task allocation application in which multiple cores execute a plurality of tasks at the same time. The run-time (or dynamic) mapping method is a method of allocating a plurality of tasks so that multiple cores execute the tasks simultaneously during application execution time.

As described above, in order to resolve the performance and power consumption problem of various application fields, research is being carried out into a method of optimally allocating the plurality of tasks of an application field in a heterogeneous multi-core system having an NoC architecture.

Conventional research chiefly proposes heuristic methods for optimally allocating a plurality of tasks in a heterogeneous multi-core system having a mesh-based NoC architecture.

### SUMMARY OF THE INVENTION

Accordingly, the present invention has been made keeping in mind the above problems occurring in the conventional art, and an object of the present invention is to provide an apparatus and method for allocating multiple tasks, which efficiently allocate multiple tasks to an application-specific star-type NoC architecture in a heterogeneous multi-core platform, thereby being able to reduce communication overhead and power consumption and also to improve the performance of the overall system.

In accordance with an aspect of the present invention, there is provided a method of allocating multiple tasks, including clustering, by a task allocation apparatus of a software (SW) platform, tasks, generated when application SW operates, based on the application SW; allocating the clustered tasks to a cluster core corresponding to the application SW; and allocating the clustered tasks to a core having a distance of one hop from the cluster core.

Allocating the clustered tasks to the core may include allocating the clustered tasks to the core having a distance of one hop from the cluster core using a round-robin method.

A method for communication between the cluster core and the core may be based on a star type network-on-chip (NoC) architecture.

The method may further include, before clustering the tasks, operating the application SW in a Linux OS of the SW platform through middleware; generating, by the Linux OS, a plurality of tasks when the application SW operates; and selecting a device driver corresponding to characteristics of each of the plurality of tasks.

In accordance with another aspect of the present invention, there is provided a method of allocating multiple tasks, including clustering, by a task allocation apparatus of a software (SW) platform, tasks based on application SW, and selecting, by the task allocation apparatus of the SW platform, a clustering core corresponding to results of the clustering; determining to allocate the tasks to a specific one of one or more cores included in the clustering core; transferring, by a process core of a hardware (HW) platform, to a central switch; transferring, by the central switch, the tasks to a switch of the clustering core; and allocating, by the switch of the clustering core, the tasks to the specific core.

In accordance with still another aspect of the present invention, there is provided an apparatus for allocating multiple tasks, including a clustering unit configured to cluster tasks, generated when application software (SW) operates in an SW platform, based on the application SW; and an allocation unit configured to allocate the clustered tasks to a cluster core corresponding to the application SW and to allocate the clustered tasks to a core having a distance of one hop from the cluster core.

The allocation unit may be further configured to allocate the clustered tasks to the core having a distance of one hop from the cluster core using a round-robin method.

A switch may be disposed between the cluster core and the core.

The switch may be based on a star type network-on-chip (NoC) architecture.

The switch may include a cross-bar switch configured to perform data parallel processing, a plurality of up-down samplers configured to sample data in order to send and receive the data, and a plurality of interfaces corresponding to interfaces of a master core and a slave core.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating the configuration of a heterogeneous multi-core platform based on a star-type NoC architecture according to an embodiment of the present invention;

FIG. 2 is a diagram illustrating the configuration of switches based on a star-type NoC architecture according to an embodiment of the present invention;

FIG. 3 is a diagram illustrating a process of allocating multiple tasks based on a star-type NoC architecture according to an embodiment of the present invention;

FIG. 4 is a flowchart illustrating a method of allocating multiple tasks according to an embodiment of the present invention;

FIG. 5 is a diagram illustrating a conventional mesh NoC-based heterogeneous multi-core platform;

FIG. 6 is a diagram illustrating a task allocation apparatus according to an embodiment of the present invention; and

FIG. 7 is a flowchart illustrating a method of allocating tasks according to an embodiment of the present invention.

### DESCRIPTION OF THE PREFERRED EMBODIMENTS

Embodiments of the present invention are described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

An apparatus and method for allocating multiple tasks, which are capable of optimally allocating multiple tasks to a heterogeneous multi-core platform based on a star-type NoC architecture, according to embodiments of the present invention are described in detail below with reference to the accompanying drawings.

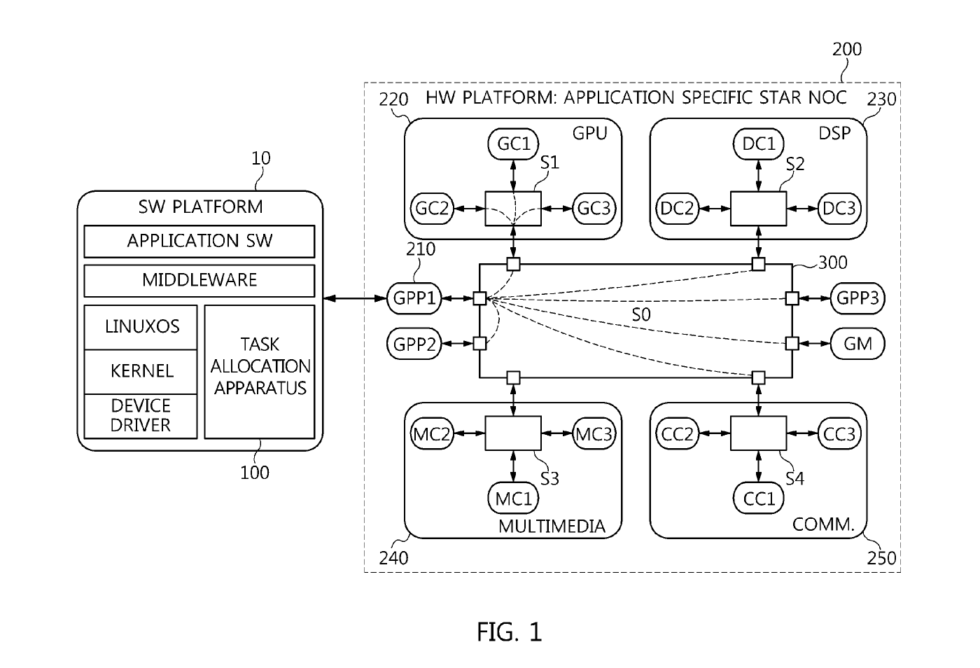

FIG. 1 is a diagram schematically illustrating the configuration of the heterogeneous multi-core platform based on a star-type NoC architecture according to an embodiment of the present invention.

Referring to FIG. 1, the heterogeneous multi-core platform based on a star-type NoC architecture includes an SW platform 10 and an HW platform 200.

The SW platform 10 classifies tasks according to their application field, and allocates the tasks to corresponding application clustering cores using a round-robin method, thereby being able to reduce communication overhead attributable to the execution of the tasks. Accordingly, power consumption can be reduced, and also the performance of the overall system can be improved.

The HW platform 200 clusters cores according to application SW, and limits the number of hops to two or less. In this case, the application SW may be multimedia, graphics, a game, communication, or the web.

For this purpose, the HW platform 200 includes a GPP1 to a GPP3 210, a GPU 220, a DSP 230, multimedia 240, communication 250, local memory (e.g., ROM or RAM), GM (e.g., SDRAM), and a communication architecture (e.g., an on-chip bus or an NoC). The multimedia 240 and the communication 250 correspond to dedicated IP-cores.

The GPU 220, the DSP 230, the multimedia 240 and the communication 250 of the HW platform 200 include respective switches S1 to S4 300. Furthermore, the HW platform 200 includes a central switch S0 that connects the switches S1 to S4 and the GPP1 to the GPP3. The central switch S0 includes a plurality of ports that are connected to the GPP1 to the GPP3, the GM, and the switches S1 to S4, respectively.

The GPP is a common process core. The GPP transfers tasks, generated when application SW is executed based on the Linux OS, to cores and HW via device drivers, thereby controlling the cores and the HW.

The GM corresponds to the common memory of the HW platform 200.

Communication between cores, such as the GPPs, and the dedicated IP-cores is performed via the switches S0 to S4 based on a star-type NoC architecture.

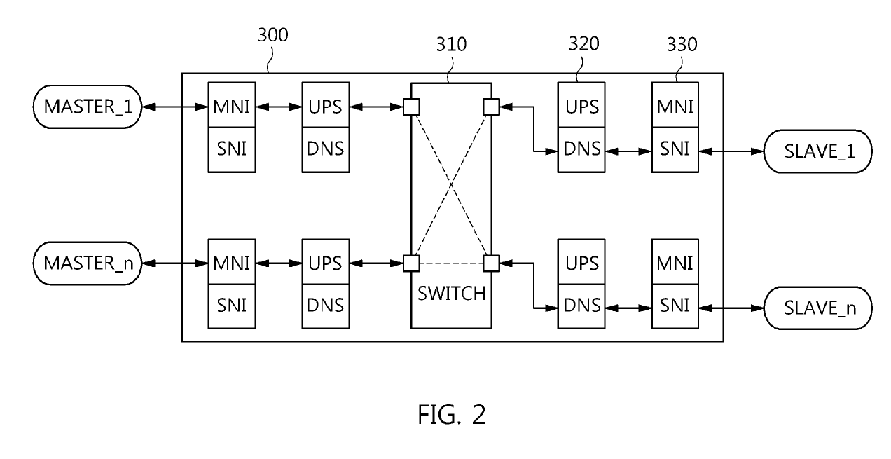

The switches based on a star-type NoC architecture are described in detail below with reference to FIG. 2.

FIG. 2 is a diagram illustrating the configuration of the switches based on a star-type NoC architecture according to an embodiment of the present invention.

Referring to FIG. 2, the switches S0 to S4 300 include a cross-bar switch 310, a plurality of up/down samplers (hereinafter referred to as “UPS/DNSs”) 320, and a plurality of master/slave interfaces (hereinafter referred to as “MNI/SNIs”) 330.

The cross-bar switch 310 enables the parallel processing of data.

The plurality of UPS/DNSs 320 sample data for the transmission and reception of the data.

The plurality of MNI/SNIs 330 corresponds to network interfaces for masters Master_1 to Master_n and slaves Slave_1 to Slave_n.

In the multi-core platform based on a star-type NoC architecture according to an embodiment of the present invention, cores are clustered into the GPP, the GPU, the DSP, the multimedia, the communication, and the memory according to their application field, and all the cores are configured to enable 2-hop communication.

In accordance with an embodiment of the present invention, a heterogeneous multi-core platform is subjected to clustering according to their application field, and is configured to form a 2-hop communication architecture, thereby being able to reduce the total number of hops and also improve the performance of the overall system. Furthermore, since the total number of hops is reduced, power consumption required for data communication can be reduced.

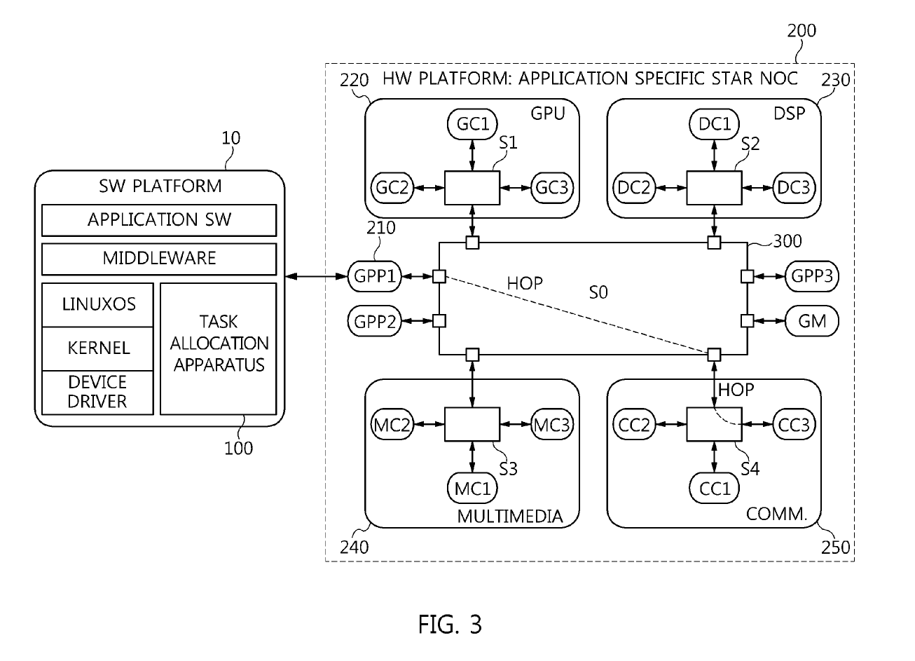

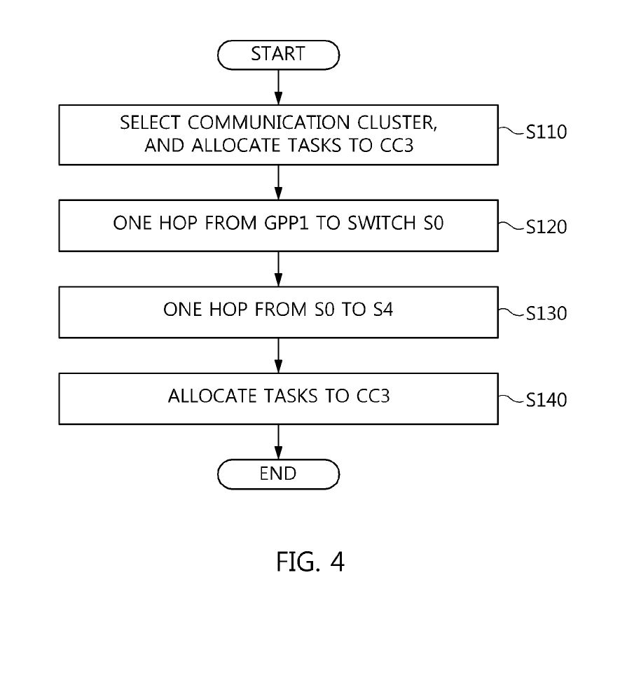

A process of allocating multiple tasks based on a star-type NoC architecture to which the 2-hop communication architecture has been applied is described in detail below with reference to FIGS. 3 and 4.

FIG. 3 is a diagram illustrating a process of allocating multiple tasks based on a star-type NoC architecture according to an embodiment of the present invention, and FIG. 4 is a flowchart illustrating a method of allocating multiple tasks according to an embodiment of the present invention.

The process of allocating multiple tasks illustrated in FIG. 3 is described based on an example in which tasks to be executed by the GPP1 210 are allocated to a CC3 included in the communication 250.

First, the task allocation apparatus 100 of the SW platform 10 clusters tasks according to their application field, and selects the communication 250 corresponding to the results of the clustering. Thereafter, the task allocation apparatus 100 allocates a task to the CC3 of cores included in the communication 250.

Referring to FIG. 4, the task allocation apparatus 100 determines to allocate the task to the CC3 of the cores included in the selected communication 250 at step S110. In this case, the task allocation apparatus 100 determines to allocate the task to the CC3, and transfers the task to the GPP1 210 based on the results of the determination.

The GPP1 210 transfers the task to the central switch S0 at step S120.

The central switch S0 transfers the task to the switch S4 included in the communication 250 at step S130.

The switch S4 transfers the task to the CC3 at step S140.

As described above, in accordance with an embodiment of the present invention, the task is allocated to the CC3 via one hop from the GPP1 210 to the central switch S0 and one hop from the central switch S0 to the switches S4, that is, a total of two hops. That is, in accordance with an embodiment of the present invention, tasks generated by the task allocation apparatus 100 may be allocated from the GPP1 to all the cores (e.g., GC1 to GC3, DC1 to DC3, MC1 to MC3, and CC1 to CC3) of all clusters (e.g., the PU 220, the DSP 230, the multimedia 240, and the communication 250) via two hops.

Accordingly, the present invention can resolve a communication overhead problem attributable to an increase in the number of hops in a conventional mesh-based multi-tasking method.

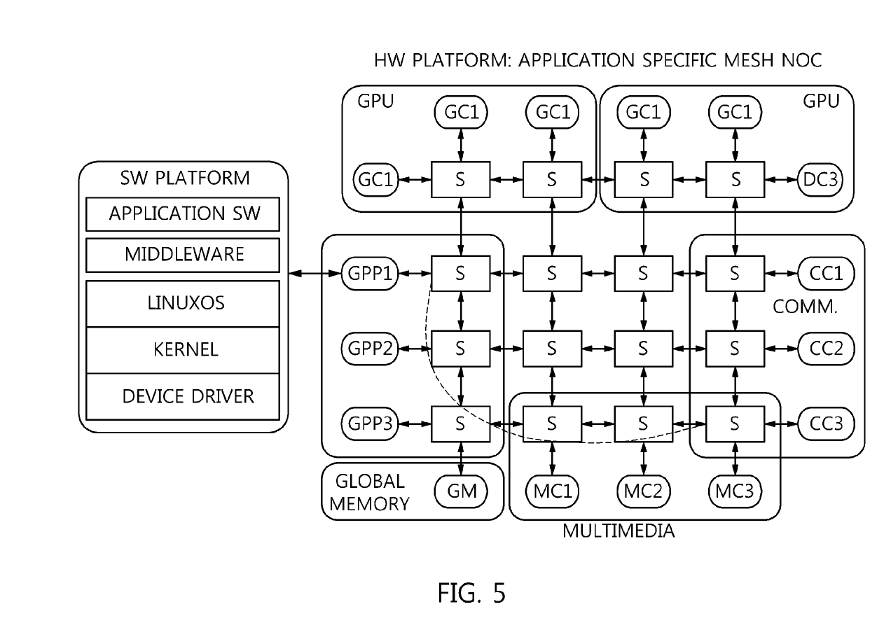

Referring to FIG. 5, in a conventional mesh NoC-based heterogeneous multi-core platform, a task needs to pass through six hops in order for the task to be allocated to the CC3 from the GPP1. Accordingly, as the number of hops increases, overall power consumption attributable to communication overhead is increased, and thus performance is deteriorated.

In general, the SW platform includes an application SW, middleware, a Linux OS, a kernel, and device drivers.

In accordance with an embodiment of the present invention, the SW platform 10 further includes the task allocation apparatus 100 in addition to the application SW, the middleware, the Linux OS, the kernel, and the device drivers.

The application SW is executed in the Linux OS via the middleware. In this case, a plurality of tasks generated is allocated to the HW platform 200 through corresponding device drivers via the kernel, and is then executed.

In a conventional method of allocating multiple tasks to a multi-core platform, available tasks generated using a heuristic method are sequentially allocated to cores included in the HW platform 200.

Recently, a method of allocating a task to a core closest to a core to which a task has been allocated, or a method of allocating a task to a core having the greatest amount of data communication is used.

In contrast, in a method of allocating tasks according to an embodiment of the present invention, the task allocation apparatus 100 of the SW platform 10 clusters generated tasks according to their application field, and allocates the tasks to cores that correspond to the results of the clustering and that are included in the HW platform 200 using a round-robin method.

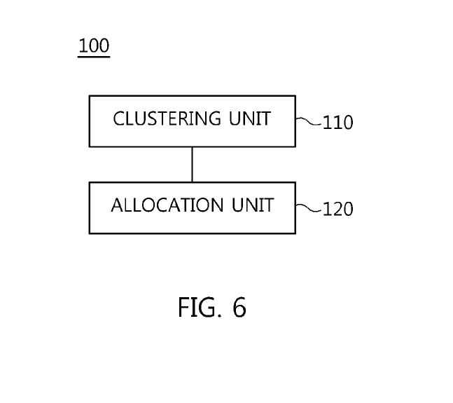

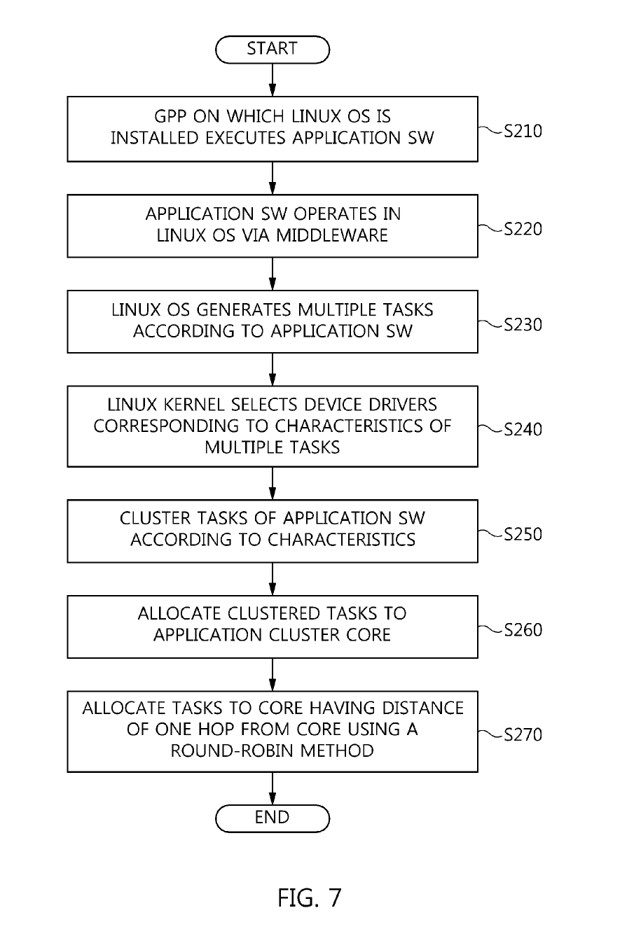

The task allocation apparatus 100 and a method in which the task allocation apparatus 100 allocates tasks are described in detail below with reference to FIGS. 6 and 7.

FIG. 6 is a diagram illustrating a task allocation apparatus according to an embodiment of the present invention, and FIG. 7 is a flowchart illustrating a method of allocating tasks according to an embodiment of the present invention.

Referring to FIG. 7, the GPP executes an application SW at step S210. In this case, the Linux OS is installed on the GPP.

The application SW operates in the Linux OS via the middleware at step S220.

The Linux OS generates a plurality of tasks when the application SW operates at step S230.

At step S240, the kernel selects a device driver according to the characteristics of each of the plurality of tasks generated at step S230.

Referring to FIG. 6, the task allocation apparatus 100 is disposed in the SW platform 10, and includes a clustering unit 110 and an allocation unit 120.

At step S250, the clustering unit 110 clusters the tasks generated at step S230 according to application SW. In this case, the application SW may be SW having a feature, such as multimedia, graphics, a game, communication or the web.

At step S260, the allocation unit 120 allocates the tasks, clustered at step S250, to clustering cores included in the HW platform 200. In this case, the clustering cores (i.e., application-specific clustering cores) correspond to cores clustered according to application SW.

For example, if the application SW corresponds to communication, the allocation unit 120 allocates the tasks, clustered at step S250, to the communication 250.

At step S270, the allocation unit 120 allocates tasks to a core having a distance of one hop from the clustering core to which the tasks have been allocated at step S260 using a round-robin method.

For example, the allocation unit 120 may allocate the tasks to the CC3 of cores included in the communication 250.

As described above, according to the present invention, tasks are classified according to their application field, and are allocated to corresponding application clustering cores using a round-robin method. Accordingly, the number of hops between cores can be reduced, and thus communication overhead between cores can be reduced. As a result, power consumption can be reduced, and the performance of the overall system can be improved.

Furthermore, in the apparatus and method for allocating multiple tasks according to the embodiments of the present invention, multiple tasks are efficiently allocated to an application-specific star-type NoC architecture in a heterogeneous multi-core platform, thereby being able to reduce communication overhead and power consumption and also improve the performance of the overall system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of allocating multiple tasks, comprising:
clustering, by a task allocation apparatus, tasks, generated when application SW operates on a software (SW) platform, based on the application SW;
allocating the clustered tasks to a cluster core corresponding to the application SW; and
allocating the clustered tasks to a core having a distance of one hop from the cluster core.

2. The method of claim 1, wherein allocating the clustered tasks to the core comprises allocating the clustered tasks to the core having a distance of one hop from the cluster core using a round-robin method.

3. The method of claim 1, wherein the cluster core communicates with the core using a method based on a star type network-on-chip (NoC) architecture.

4. The method of claim 1, further comprising, before clustering the tasks:
operating the application SW in a Linux OS of the SW platform through middleware;
generating, by the Linux OS, a plurality of tasks when the application SW operates; and
selecting a device driver corresponding to characteristics of each of the plurality of tasks.

5. A method of allocating multiple tasks, comprising:
clustering, by a task allocation apparatus, tasks based on application software (SW), and selecting a clustering core corresponding to results of the clustering in a software (SW) platform;
determining to allocate the tasks to a specific one of one or more cores included in the clustering core;
transferring, by a process core of a hardware (HW) platform, to a central switch;
transferring, by the central switch, the tasks to a switch of the clustering core; and
allocating, by the switch of the clustering core, the tasks to the specific core.

6. An apparatus for allocating multiple tasks, comprising:
a clustering unit configured to cluster tasks, generated when application software (SW) operates in an SW platform, based on the application SW; and
an allocation unit configured to allocate the clustered tasks to a cluster core corresponding to the application SW and to allocate the clustered tasks to a core having a distance of one hop from the cluster core.

7. The apparatus of claim 6, wherein the allocation unit is configured to allocate the clustered tasks to the core having a distance of one hop from the cluster core using a round-robin method.

8. The apparatus of claim 6, wherein a switch is disposed between the cluster core and the core.

9. The apparatus of claim 8, wherein the switch is based on a star type network-on-chip (NoC) architecture.

10. The apparatus of claim 9, wherein the switch comprises a cross-bar switch configured to perform data parallel processing, a plurality of up-down samplers configured to sample data in order to send and receive the data, and a plurality of interfaces corresponding to interfaces of a master core and a slave core.
